(19) United States
(12) Patent Application Publication
(10) Pub. No.: US 2014/0278954 A1
(43) Pub. Date: Sep. 18, 2014

(54) AUTOMATED PRODUCT OFFER MANAGEMENT

(71) Applicant: Verizon Patent and Licensing Inc., Basking Ridge, NJ (US)

(72) Inventors: Clifford A. Suzuki, San Jose, CA (US); Frederick G. Wade, Oakland, CA (US)

(73) Assignee: Verizon Patent and Licensing Inc., Basking Ridge, NJ (US)

(21) Appl. No.: 13/931,352

(22) Filed: Jun. 28, 2013

Related U.S. Application Data
(60) Provisional application No. 61/786,174, filed on Mar. 14, 2013.

(51) Int. Cl. G06Q 30/02

(52) U.S. Cl. CPC G06Q 30/0251
USPC 705/14.49

(57) ABSTRACT

In embodiments, apparatuses, methods and storage media are described that are associated with automated content offer management. In various embodiments, an automated offer management system (“AOM”) may be configured to generate offers for products and/or content. The AOM may obtain information about content, such as from content providers. The AOM may also obtain information about consumers. The AOM may then apply one or more configurable business rules to the received content information and consumer information to generate offers. Offers may then be reviewed and provisioned to content consumers. Other embodiments may be described and claimed.

### RELATED APPLICATION

This application claims the benefit of U.S. Provisional Application No. 61/786,174, filed Mar. 14, 2013 and titled “Automated Product Offer Management,” the specification of which is hereby incorporated by reference.

### TECHNICAL FIELD

The present disclosure relates to the field of data processing, in particular, to apparatuses, methods and storage media associated with facilitating management of offers for content and other products.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of content, and the manners in which the content is consumed. Today, myriad content may be made available from various sources of content, including but not limited to fixed medium (e.g., Digital Versatile Disk (DVD)), broadcast, cable operators, satellite channels, Internet, and so forth. In some circumstances, content may be offered for purchase and/or rental.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an arrangement for content distribution and consumption, in accordance with various embodiments.

FIG. 2 illustrates an example process for generating offers for products, in accordance with various embodiments.

FIG. 3 illustrates an example process for configuring business rules for content offer generation, in accordance with various embodiments.

FIG. 4 illustrates an example process for configuring offer modifications, in accordance with various embodiments.

FIG. 5 illustrates an example process for generating offers, in accordance with various embodiments.

FIG. 6 illustrates an example process for provisioning offers, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an arrangement for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106.

In embodiments, as shown, content aggregator/distributor servers 104 may include encoder 112, storage 114 and content provisioning 116, which may be coupled to each other as shown. Encoder 112 may be configured to encode content 102 from various content creators and/or providers 101, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers 101. Examples of content may include, but are not limited to, movies, TV programming, user created content (such as YouTube video, iReporter video), music albums/titles/pieces, and so forth. Examples of content creators and/or providers 101 may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein. Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. In various embodiments, content provisioning 116 may be configured to provide media files that are packaged according to one or more output packaging formats. In various embodiments, content provisioning 116 may include a transpackager, such as illustrated in FIG. 2 below, which may be configured to package content files encoded by the encoder 112 in one or more output packaging formats for subsequent provisioning. Particular embodiments of transpackagers and transpackaging may be described below.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device 126. Player 122 may be configured to receive streamed content, decode and recover the content from the content stream, and present the recovered content on display 124, in response to user selections/inputs from user input device 126.

In various embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. In various embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein.

While shown as part of a content consumption device 108, display 124 and/or user input device(s) 126 may be stand-alone devices or integrated, for different embodiments of content consumption devices 108. For example, for a television arrangement, display 124 may be a stand alone television set, Liquid Crystal Display (LCD), Plasma and the like, while player 122 may be part of a separate set-top set, and user input device 126 may be a separate remote control, gaming controller, keyboard, or another similar device. Similarly, for a desktop computer arrangement, player 122, display 124 and user input device(s) 126 may all be separate stand alone units. On the other hand, for a tablet arrangement, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

In various embodiments, an automated offer management system 110 (“AOM 110”) may communicate with various other entities described herein, including the content creators/providers 101, the content aggregator/distributor server(s) 104 and/or the content consumption device(s) 108. In various embodiments, the AOM 110 may include one or more software and/or hardware modules configured to generate offers for content. For example, in various embodiments, the AOM 110 may include one or more of a business rule configuration module 120, business rule storage 125, offer generation module 130, offer provision module 140, and/or offer review module 150.

In various embodiments, the AOM 110 may be configured, such as through action of an offer generation module 1230, to generate offers for various forms of content, including television episodes, movies, web-based content, image and/or textual content, etc. In various embodiments, the AOM 110 may be configured to generate offers for direct purchase of content, such as for purchases of discrete pieces of content, e.g. movies or television episodes. In other embodiments, the offer generation module 130 of the AOM 110 may be configured to generate offers for ongoing content consumption, such as access to a season (or even an entire series) of television episodes, access to a series of films, access to a content library, etc. In various embodiments, the content offers which are generated by the offer generation module 130 of the AOM 110 may provide for substantially contemporaneous access and/or download of the content, and/or for future access. It may be noted that, while the AOM 110 is generally described herein as generating content for offers for the purpose of simple description, in various embodiments, the AOM 110 may be configured to generate offers for non-content products, such as physical goods, and/or services.

In various embodiments, the offer generation module 130 of the AOM 110, or another module, may be configured to communicate with the content creators/providers 101 to obtain information about content which may be used to generate one or more offers. The information obtained by the AOM 110 may include, but is not limited to: content titles, genres, dates, content creator information, country and/or region of creation, content length, content formats, digital rights management information, information about associated content, suggested price, etc. In various embodiments, the AOM 110 may be configured to receive content information from the content creators/providers 101 during an initial receipt of information about a piece of content; in other embodiments, the AOM 110 may be configured to receive additional content after receipt of the initial content; such receipt of information may as on a regular schedule or on an unscheduled basis. In various embodiments, the AOM 110 may be configured to present, or facilitate presentation of, one or more interfaces to content creators/providers 101 to receive content information for generation of offers.

In various embodiments, the offer generation module 130 of the AOM 110 may be configured to communicate with content consumers to receive content consumer information for generation of offers. In various embodiments, the AOM 110 may receive content consumer information from one or more entities, such as from the content aggregator/distributor server(s) 104 and/or the content consumption device(s) 108. In various embodiments, content consumer information may include, but is not limited to content consumer identity, age, address or location, gender, income, content purchase history and/or other content purchase history. Content consumer information may also include, but is not limited to, known content and/or content preferences of the content consumer. In various embodiments, content consumer information used for generation of offers may include information about consumers other than a content consumer to whom an offer is being presented.

In various embodiments, the offer generation module 130 of the AOM 110 may be configured to apply one or more business rules to content information and content consumer information received in order to generate one or more content offers. In various embodiments, the AOM 110 may store the business rules locally, such as in the business rule storage 125, or remotely and may apply the business rules, such as through execution of a business rules engine of the offer generation module 130 configured to apply stored business rules. In other embodiments, business rules may not be separately stored, but may be incorporated into activities of the AOM 110. In various embodiments, the business rule configuration module 120 of the AOM 110 may be configured to provide for configuration of the business rules, such as through interaction with one or more offer reviewers/operators 115.

In various embodiments, the AOM 110 may be configured to provision offers to content consumers, such as through operation of the offer provision module 140. Content consumers may be users of the content consumption device(s) 108 (not illustrated). In various embodiments, the offer provision module 140 of the AOM 110 may be configured to provision the offers to content consumers through the content consumption device(s) 108, as illustrated, or through other means. In various embodiments, the offer provision module 140 of the AOM 110 may be configured to present, or facilitate presentation of, one or more interfaces for offer presentation and/or acceptance. In various embodiments, when the offer provision module 140 of the AOM 110 is configured to receive acceptance of offers, the offer provision module 140 of the AOM 110 may be configured to receive content consumer financial information for payments, and to communicate with financial institutions for processing of payments. In other embodiments, the AOM 110 may be configured to provide offer information for presentation and/or acceptance by other entities (such as, for example the content consumption device(s) 108) without providing a facility on its own for offer processing.

In various embodiments, the AOM 110 may communicate with one or more offer reviewers/operators 115 (“reviewers 115”), such as through operation of the offer review module 150. In various embodiments, the offer review module 150 of the AOM 110 may be configured to present generated offers to the reviewers 115 for review. In various embodiments, the offer review module 150 of the AOM 110 may be configured to generate exceptions for reviewers 115, such that reviewers may review and/or modify business rules that may be used by the AOM 110 to generate offers. In other embodiments, the offer review module 150 of the AOM 110 may be configured to allow for direct review and/or modification of offers by reviewers 115. In some embodiments, this review may be performed before offers are presented to content consumers. In other embodiments, reviewers 115 may review and modify offers after they have been presented to content consumers.

Referring now to FIG. 2, an example process 200 for generating offers for content is illustrated in accordance with various embodiments. In various embodiments, the operations described in process 200 may be combined, split into additional operations, and/or omitted. The process may begin at operation 210, where the AOM 110 may facilitate configuration of one or more business rules for offer generation. Particular examples of implementations of operation 210 are described below with reference to process 300 of FIG. 3. Next at operation 220, the AOM may facilitate configuration of modifications for offer generation. Particular examples of implementations of operation 220 are described below with reference to process 400 of FIG. 4.

Next, at operation 230, the AOM may receive content information, such as described above. In various embodiments, the content information may include content information such as described above. In various embodiments, as described herein, the content information may be received, in various embodiments, by content creators/providers 101. Next, at operation 240, the AOM 110 may receive information about the content consumer for whom the offer may be generated. In various embodiments, additional content consumer information may be received at operation 240, such as information about similar content consumers. Next, at operation 250, the AOM 110 may generate offers, such as through application of business rules to the various information received at operations 230 and 240. Particular examples of implementations of operation 250 are described below with reference to process 500 of FIG. 5. Next, at operation 260, the AOM 110 may provision offers for acceptance by content consumers. Particular examples of implementations of operation 250 are described below with reference to process 600 of FIG. 6. The process may then end.

FIG. 3 an example process 300 for configuring business rules for content offer generation, in accordance with various embodiments. In various embodiments, the operations described in process 300 may be combined, split into additional operations, and/or omitted. In various embodiments, process 300 may implement one or more embodiments of operation 210 of process 200 of FIG. 2. In various embodiments, process 300 may be performed, in whole or in part by the business rule configuration module 120 of the AOM 110. In various embodiments, operations of process 300 may involve the identification of one or more business rules by the AOM 110. In various embodiments, the AOM 110 may identify business rules by receiving explicit indications of business rules from entities, such as content creators/providers 101 and/or reviewers 115. In other embodiments, the AOM 110 may include one or more business rules that are pre-configured, in whole or in part, and which may by selected and/or configured by content creators/providers 101 and/or reviewers 115. While business rules are identified in the example process 300 according to individual types, it may be recognized that, in various embodiments, business rules may be based on one or more of the categories discussed herein. Additionally, while particular examples of business rules are provided below, it may be recognized that embodiments described herein are not limited thereby and that, in various embodiments, other business rules are contemplated.

The process may begin at operation 310, the AOM 110 may identify one or more business rules relating to media types. For example, in various embodiments, at operation 310 business rules may be identified based on whether the content is audio or video content. In various embodiments, business rules may be identified based on what type of media the content was developed for, such as television, film, or web-based content. In various embodiments, at operation 310, business rules may be identified based on content format and/or content protection, such as whether the content is encoded in an unprotected format or whether digital rights management techniques are used to protect the content.

Next, at operation 320, the AOM 110 may identify one or more business rules relating to content creators/providers 101. In various embodiments, business rules identified at operation 320 may include default rules relating to all content (or all content of a particular type) produced by a particular content creator/provider 101. For example, a movie studio may identify a base price for all movies produced by the studio. In another example, a television channel may identify per-episode prices for all shows associated with that channel.

Next, at operation 330, the AOM 110 may identify one or more business rules based on particular pieces of content. For example, specific rules relating to particular pieces of content may be identified. Next, at operation 340, the AOM 110 may identify one or more business rules based on content consumers. For example, at operation 340, a special price reduction rule may be identified for content consumers that are new to purchasing content or that have not purchased content recently. In another embodiment, business rules may be identified to modify prices based on content consumer interest, such as that evidenced by past purchases or viewing history. Finally, at operation 350, the AOM 110 may identify one or more business rules relating to redemption of offers. For example, in various embodiments, the AOM 110 a business rule may provide for a different price for content purchased through an online payment service, as opposed to a credit card or check purchase. In other embodiments, a business rule may provide for a reduction in price if a piece of content is purchased along with viewing of an advertisement, or along with purchase of a separate piece of content, or through redemption of a purchase code obtained from a retail establishment. In various embodiments, business rules may provide for time-based redemption, such that, for example, a discount may only apply during a particular time period. The process may then end.

Referring now to FIG. 4, an example process 400 for configuring offer modifications is illustrated, in accordance with various embodiments. In various embodiments, the operations described in process 400 may be combined, split into additional operations, and/or omitted. In various embodiments, process 400 may implement one or more embodiments, of operation 220 of process 200 of FIG. 2. In various embodiments, process 400 may be performed, in whole or in part by the business rule configuration module 120 of the AOM 110. In various embodiments, the AOM 110 may perform process 400 in order to configure modifications to existing business rules, such as for content that should be handled under an exception. The process may begin at operation 410, where the AOM 110 may identify one or more content modifications to the business rules. In various embodiments, the content modifications may include exceptions based on recent availability of an item, such as a new release movie. In various embodiments, modifications may be made based on popularity of an piece of content, a content creator, or on other content information. Next, at operation 420, the AOM 110 may identify one or more time-based modifications to the business rules. For example, a modification may be identified to create a discount on particular content for a limited amount of time. In another example, a modification may be identified to create a discount leading up to a specified time or starting at a specified time, such as a content release. Next, at operation 430, the AOM 110 may identify content consumer modifications. For example, in various embodiments, at operation 430, the AOM 110 may identify modifications to provide discounts to particular content consumers, such as new customers, customers with particular purchase histories, and/or customers fitting particular demographic models. The process may then end.

Referring now to FIG. 5, an example process 500 for generating offers is illustrated, in accordance with various embodiments. In various embodiments, the operations described in process 500 may be combined, split into additional operations, and/or omitted. In various embodiments, process 500 may implement one or more embodiments of operation 250 of process 200 of FIG. 2. In various embodiments, process 500 may be performed, in whole or in part by the offer generation module 130 of the AOM 110. In various embodiments, the AOM 110 may perform process 500 in order to confirm that offers can be generated and then to generate offers for content. The process may begin at operation 510, where the AOM 110 may confirm whether sufficient content data is available to the AOM 110 to support application of business rules. In various embodiments, the content data checked at operation 510 may include bibliographic data describing the content, such as title, creator, year of release, etc. In various embodiments, at operation 510 the AOM 110 may also determine whether various content assets are available to make the offer. For example, if an offer may include a movie along with extra videos of cast interviews, at operation 510 the AOM 110 may determine whether each of the included videos have been received (such as by the content aggregator/distributor server(s) 104) before allowing the offer to be generated. If sufficient content data is not available, then the process may generate an alert at operation 560, such as by sending a message to reviewers 115, and the process may end.

If sufficient content data is available, then at operation 520 the AOM 110 may determine whether sufficient offer data is available to the AOM 110 to support application of business rules. For example, at operation 520, the AOM 110 may determine whether the business rules are sufficiently defined to generate offers for a given region, or demographic. If not, then, the process may proceed to operation 560 and generate an alert.

Next, at operation 530, the AOM 110 may apply business rules to a piece of content and determine offer details, such as price, time limits, redemption rules, etc. Next, at operation 540, the AOM 110 may apply one or more exceptions, such as those exceptions identified at operation 400 of FIG. 4 to the offer. Then, at operation 550, the AOM 110 may generate an offer, such as by generating a presentation for the offer details generated at operation 530. The process may then end.

Referring now to FIG. 6, an example process 600 for provisioning offers is illustrated, in accordance with various embodiments. In various embodiments, the operations described in process 600 may be combined, split into additional operations, and/or omitted. In various embodiments, process 600 may implement one or more embodiments of operation 260 of process 200 of FIG. 2. In various embodiments, process 600 may be performed, in whole or in part by the offer provision module 140 and/or the offer review module 150 of the AOM 110. The process may begin at operation 610, where the AOM 110 may provide a generated offer for review, such as by the offer reviewers/operators 115. Next, at operation 620, the AOM 110 may provision the generated offer for acceptance by a content consumer. In various embodiments, the AOM 110 may be configured to provision the offer through the content consumption device 108. In other embodiments, the AOM 110 may provide an interface for provision of the generated offer, or may provision the offer through another manner. In various embodiments, process 600 may return to operation 610, where the provisioned offer may be reviewed after provisioning. Next, at operation 630, the AOM 110 may receive acceptance of the generated offer from a content consumer. In various embodiments, the AOM 110 may receive an indication, such as from the content consumption device 108, that the offer has been accepted. Next, at operation 640, the AOM 110 may facilitate payment for the offer by the content consumer. In various embodiments, the AOM 110 may be configured to directly accept payment; in other embodiments, the AOM 110 may facilitate acceptance of payment through another entity. The process may then end.

Referring now to FIG. 7, an example computer suitable for use for various components and processes of FIGS. 2-6 is illustrated in accordance with various embodiments. In embodiments, the computer 700 may be suitable for use as a stationary or mobile computing device. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the operations associated with SVM 110, e.g., operations shown in FIGS. 2-6. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices.

The number, capability and/or capacity of these elements 710-712 may vary, depending on whether computer 700 is a stationary or mobile device, like a smartphone, computing tablet, ultrabook or laptop. Their constitutions are otherwise known, and accordingly will not be further described.

FIG. 8 illustrates an example least one computer-readable storage medium 802 having instructions configured to practice all or selected ones of the operations associated with content consumption devices 108, earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2-6, e.g., but not limited to, to the various operations performed to facilitate generation of offers for content and/or products. In alternate embodiments, programming instructions 804 may be disposed on multiple least one computer-readable storage media 802 instead.

Referring back to FIG. 7, for one embodiment, at least one of processors 702 may be packaged together with computational logic 722 configured to practice aspects of processes of FIGS. 2-6. For one embodiment, at least one of processors 702 may be packaged together with computational logic 722 configured to practice aspects of processes of FIGS. 2-6 to form a System in Package (SiP). For one embodiment, at least one of processors 702 may be integrated on the same die with computational logic 722 configured to practice aspects of processes of FIGS. 2-6. For one embodiment, at least one of processors 702 may be packaged together with computational logic 722 configured to practice aspects of processes of FIGS. 2-6 to form a System on Chip (SoC). For at least one embodiment, the SoC may be utilized in, e.g., but not limited to, a computing tablet.

Various embodiments of the present disclosure have been described. These embodiments include, but are not limited to, those described in the following paragraphs.

Example 1 may include one or more computer-readable media including instructions configured such that, upon execution on a computing device, the instructions cause the computing device to generate offers for content. The instructions may cause the computing device to receive content information associated with a piece of content and apply one or more business rules to the received information to generate an offer for the content.

Example 2 may include the computer-readable media of Example 1, wherein the instructions are further configured to cause the computing device to facilitate configuration of one or more of the business rules.

Example 3 may include the computer-readable media of Example 2, wherein facilitate configuration of one or more of the business rules includes identify one or more rules based on one or more of: media type information, content provider information, information relating to particular pieces of content, content consumer information, and/or redemption information.

Example 4 may include the computer-readable media of any of Examples 1-3, wherein the instructions are further configured to cause the computing device to facilitate configuration of offer modifications.

Example 5 may include the computer-readable media of Example 4, wherein facilitate configuration of one or more offer modifications includes identify one or more offer modifications based on one or more of: content information, time-based information, and/or content consumer information.

Example 6 may include the computer-readable media of any of Examples 1-5, wherein apply one or more business rules includes, prior to application of one or more business rules, confirm whether sufficient data is available to the computing device to support application of the one or more business rules.

Example 7 may include the computer-readable media of Example 6, wherein confirm whether sufficient data is available includes confirm whether sufficient content data is available.

Example 8 may include the computer-readable media of Example 6, wherein confirm whether sufficient data is available includes confirm whether sufficient offer data is available.

Example 9 may include the computer-readable media of any of Examples 1-8, wherein apply one or more business rules includes apply one or more modifications to offers after application of the one or more business rules.

Example 10 may include the computer-readable media of any of Examples 1-9, wherein the instructions are further configured to cause the computing device to provision the generated offer to a content consumer.

Example 11 may include the computer readable media of Example 10, wherein provision the generated offers to a content consumer includes provision the generated offer to the content consumer through a content consumption device.

Example 12 may include the computer readable media of Example 10, wherein the instructions are further configured to cause the computing device to receive an acceptance of the offer from the content consumer.

Example 13 may include the computer-readable media of any of Examples 1-12, wherein the instructions are further configured to cause the computing device to provide the generated offer to one or more offer reviewers for review.

Example 14 may include the computer-readable media of any of Examples 1-13, wherein the instructions are further configured to cause the computing device to receive the information from a content creator for the content.

Example 15 may include the computer-readable media of any of Examples 1-14, wherein the instructions are further configured to cause the computing device to receive content consumer information associated with a content consumer, and wherein apply the one or more business rules includes apply the one or more business rules to both the content information and the content consumer information.

Example 16 may include an apparatus for generating offers for content. The apparatus may include one or more computer processors and an offer generation module configured to operate on the one or more computer processors. The offer generation module may be configured to receive content information associated with a piece of content and apply one or more business rules to the received information to generate an offer for the content.

Example 17 may include the apparatus of Example 16, further including a business rule configuration module configured to operate on the one or more computer processors to facilitate configuration of one or more of the business rules.

Example 18 may include the apparatus of Example 17, wherein facilitate configuration of one or more of the business rules includes identify one or more rules based on one or more of: media type information, content provider information, information relating to particular pieces of content, content consumer information, and/or redemption information.

Example 19 may include the apparatus of Example 17, wherein the business rule configuration module is further configured to facilitate configuration of offer modifications.

Example 20 may include the apparatus of Example 19, wherein facilitate configuration of one or more offer modifications includes identify one or more offer modifications based on one or more of: content information, time-based information, and/or content consumer information.

Example 21 may include the apparatus of any of Examples 16-20, wherein apply one or more business rules includes, prior to application of one or more business rules, confirm whether sufficient data is available to the computing device to support application of the one or more business rules.

Example 22 may include the apparatus of Example 21, wherein confirm whether sufficient data is available includes confirm whether sufficient content data is available.

Example 23 may include the apparatus of Example 21, wherein confirm whether sufficient data is available includes confirm whether sufficient offer data is available.

Example 24 may include the apparatus of any of Examples 16-23, wherein apply one or more business rules includes apply one or more modifications to offers after application of the one or more business rules.

Example 25 may include the apparatus of any of Examples 16-24, further including an offer provision module configured to operate on the one or more computer processors to provision the generated offer to a content consumer.

Example 26 may include the apparatus of Example 25, wherein provision the generated offers to a content consumer includes provision the generated offer to the content consumer through a content consumption device.

Example 27 may include the apparatus of Example 25, wherein the offer provision module is further configured to operate on the one or more computer processors to receive an acceptance of the offer from the content consumer.

Example 28 may include the apparatus of any of Examples 16-27, further including an offer review module configured to operate on the one or more computer processors to provide the generated offer to one or more offer reviewers for review.

Example 29 may include the apparatus of any of Examples 16-28, wherein the offer generation module is further configured to operate on the one or more computer processors to receive the information from a content creator for the content.

Example 30 may include the apparatus of any of Examples 16-29, wherein the offer generation module is further configured to operate on the one or more computer processors to receive content consumer information associated with a content consumer and apply the one or more business rules to both the content information and the content consumer information.

Example 31 may include a computer-implemented method for generating offers for content. The method may include receiving, by a computing device, content information associated with a piece of content and applying, by the computing device, one or more business rules to the received information to generate an offer for the content.

Example 32 may include the method of Example 31, further including facilitating, by the computing device, configuration of one or more of the business rules.

Example 33 may include the method of Example 32, wherein facilitating configuration of one or more of the business rules includes identifying one or more rules based on one or more of: media type information, content provider information, information relating to particular pieces of content, content consumer information, and/or redemption information.

Example 34 may include the method of any of Examples 31-33, further including facilitating, by the computing device, configuration of offer modifications.

Example 35 may include the method of Example 34, wherein facilitating configuration of one or more offer modifications includes identifying one or more offer modifications based on one or more of: content information, time-based information, and/or content consumer information.

Example 36 may include the method of any of Examples 31-35, wherein applying one or more business rules includes, prior to application of one or more business rules, confirming whether sufficient data is available to the computing device to support application of the one or more business rules.

Example 37 may include the method of Example 36, wherein confirming whether sufficient data is available includes confirming whether sufficient content data is available.

Example 38 may include the method of Example 36, wherein confirming whether sufficient data is available includes confirming whether sufficient offer data is available.

Example 39 may include the method of any of Examples 31-38, wherein applying one or more business rules includes applying one or more modifications to offers after application of the one or more business rules.

Example 40 may include the method of any of Examples 31-39, further including provisioning, by the computing device, the generated offer to a content consumer.

Example 41 may include the method of Example 40, wherein provisioning the generated offers to a content consumer includes provisioning the generated offer to the content consumer through a content consumption device.

Example 42 may include the method of Example 40, further including receiving, by the computing device, an acceptance of the offer from the content consumer.

Example 43 may include the method of any of Examples 31-42, further including providing, by the computing device, the generated offer to one or more offer reviewers for review.

Example 44 may include the method of any of Examples 31-43, further including receiving, by the computing device, the information from a content creator for the content.

Example 45 may include the method of any of Examples 31-44, wherein the method further includes receiving, by the computing device, content consumer information associated with a content consumer and applying the one or more business rules includes applying the one or more business rules to both the content information and the content consumer information.

Example 46 may include an apparatus for generating offers for content. The apparatus may include means for receiving content information associated with a piece of content and means for applying one or more business rules to the received information to generate an offer for the content.

Example 47 may include the apparatus of Example 46, further including means for facilitating configuration of one or more of the business rules.

Example 48 may include the apparatus of Example 47, wherein means for facilitating configuration of one or more of the business rules includes means for identifying one or more rules based on one or more of: media type information, content provider information, information relating to particular pieces of content, content consumer information, and/or redemption information.

Example 49 may include the apparatus of any of Examples 46-48, further including means for facilitating configuration of offer modifications.

Example 50 may include the apparatus of Example 49, wherein means for facilitating configuration of one or more offer modifications includes means for identifying one or more offer modifications based on one or more of: content information, time-based information, and/or content consumer information.

Example 51 may include the apparatus of any of Examples 46-50, wherein means for applying one or more business rules includes, means for, prior to application of one or more business rules, confirming whether sufficient data is available to the computing device to support application of the one or more business rules.

Example 52 may include the apparatus of Example 51, wherein means for confirming whether sufficient data is available includes means for confirming whether sufficient content data is available.

Example 53 may include the apparatus of Example 51, wherein means for confirming whether sufficient data is available includes means for confirming whether sufficient offer data is available.

Example 54 may include the apparatus of any of Examples 46-53, wherein means for applying one or more business rules includes means for applying one or more modifications to offers after application of the one or more business rules.

Example 55 may include the apparatus of any of Examples 46-54, further including means for provisioning the generated offer to a content consumer.

Example 56 may include the apparatus of Example 55, wherein means for provisioning the generated offers to a content consumer includes means for provisioning the generated offer to the content consumer through a content consumption device.

Example 57 may include the apparatus of Example 55, further including means for receiving an acceptance of the offer from the content consumer.

Example 58 may include the apparatus of any of Examples 46-57, further including means for providing the generated offer to one or more offer reviewers for review.

Example 59 may include the apparatus of any of Examples 46-58, further including means for receiving the information from a content creator for the content.

Example 60 may include the apparatus of any of Examples 46-59, wherein the apparatus further includes means for receiving content consumer information associated with a content consumer and means for applying the one or more business rules includes means for applying the one or more business rules to both the content information and the content consumer information.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions configured such that, upon execution on a computing device, the instructions cause the computing device to:
receive content information associated with a piece of content; and
apply one or more business rules to the received information to generate an offer for the content.

2. The computer-readable media of claim 1, wherein the instructions are further configured to cause the computing device to facilitate configuration of one or more of the business rules.

3. The computer-readable media of claim 2, wherein facilitate configuration of one or more of the business rules comprises identify one or more rules based on one or more of: media type information, content provider information, information relating to particular pieces of content, content consumer information, and/or redemption information.

4. The computer-readable media of claim 1, wherein the instructions are further configured to cause the computing device to facilitate configuration of offer modifications.

5. The computer-readable media of claim 4, wherein facilitate configuration of one or more offer modifications comprises identify one or more offer modifications based on one or more of: content information, time-based information, and/or content consumer information.

6. The computer-readable media of claim 1, wherein apply one or more business rules comprises, prior to application of one or more business rules, confirm whether sufficient data is available to the computing device to support application of the one or more business rules.

7. The computer-readable media of claim 6, wherein confirm whether sufficient data is available comprises confirm whether sufficient content data is available.

8. The computer-readable media of claim 6, wherein confirm whether sufficient data is available comprises confirm whether sufficient offer data is available.

9. The computer-readable media of claim 1, wherein apply one or more business rules comprises apply one or more modifications to offers after application of the one or more business rules.

10. The computer-readable media of claim 1, wherein the instructions are further configured to cause the computing device to provision the generated offer to a content consumer.

11. The computer readable media of claim 10, wherein provision the generated offers to a content consumer comprises provision the generated offer to the content consumer through a content consumption device.

12. The computer readable media of claim 10, wherein the instructions are further configured to cause the computing device to receive an acceptance of the offer from the content consumer.

13. The computer-readable media of claim 1, wherein the instructions are further configured to cause the computing device to provide the generated offer to one or more offer reviewers for review.

14. The computer-readable media of claim 1, wherein the instructions are further configured to cause the computing device to receive the information from a content creator for the content.

15. The computer-readable media of claim 1, wherein the instructions are further configured to cause the computing device to:
receive content consumer information associated with a content consumer; and
wherein apply the one or more business rules comprises apply the one or more business rules to both the content information and the content consumer information.

16. An apparatus comprising:
one or more computer processors; and
an offer generation module configured to operate on the one or more computer processors:
receive content information associated with a piece of content; and
apply one or more business rules to the received information to generate an offer for the content.

17. The apparatus of claim 16, further comprising a business rule configuration module configured to operate on the one or more computer processors to facilitate configuration of one or more of the business rules.

18. The apparatus of claim 17, wherein the business rule configuration module is further configured to facilitate configuration of offer modifications.

19. The apparatus of claim 16, wherein apply one or more business rules comprises, prior to application of one or more business rules, confirm whether sufficient data is available to the computing device to support application of the one or more business rules.

20. The apparatus of claim 16, further comprising an offer review module configured to operate on the one or more computer processors to provide the generated offer to one or more offer reviewers for review.

21. A computer-implemented method comprising:
receiving, by a computing device, content information associated with a piece of content; and
applying, by the computing device, one or more business rules to the received information to generate an offer for the content.

22. The method of claim 21, further comprising facilitating, by the computing device, configuration of one or more of the business rules.

23. The method of claim 21, further comprising facilitating, by the computing device, configuration of offer modifications.

24. The method of claim 21, wherein applying one or more business rules comprises, prior to application of one or more business rules, confirming whether sufficient data is available to the computing device to support application of the one or more business rules.

25. The method of claim 21, further comprising providing, by the computing device, the generated offer to one or more offer reviewers for review.
